(19) United States
(12) Patent Application Publication
(10) Pub. No.: US 2011/0035030 A1
(43) Pub. Date: Feb. 10, 2011

(54) Lossless Normalization of Media Files

(76) Inventor: Bjorn Michael Dittmer-Roche, Brooklyn, NY (US)

Correspondence Address: Bjorn Michael Dittmer Roche, POBox 8537, New York, NY, 10016-8537, US

(21) Appl. No.: 12/535,691

(22) Filed: Aug. 5, 2009

(51) Int. Cl. G06F 17/00

(52) U.S. Cl. 700/94

(57) ABSTRACT

A request to normalize at least one media file is received. A peak amplitude associated with the at least one media file is determined, and a target maximum volume associated with playback of the at least one media file is also determined. The at least one media file is played, and a constant scaling factor is applied to the at least one media file substantially concurrently with playback, the scaling factor calculated to cause the peak amplitude to play at the target maximum volume.

### BACKGROUND

Many digital audio editing software packages offer the ability to normalize audio files (or the audio track of a media file), a process of adjusting (often increasing) the volume of an audio file so that the loudest volume in a file is equal to some prescribed level (usually, though not necessarily, 0 dBFS). Traditional normalization involves scanning the file to find the loudest part (the “peak amplitude”), and then rewriting the entire file multiplied by an appropriate “scaling factor,” which is defined such that the peak now plays at a desired level. In some instances, the initial scan may be omitted if the audio file format already has information regarding the peak amplitude stored as metadata.

In some normalization algorithms, certain actions may be taken in order to preserve audio information in the original file that might otherwise be lost when the file is rewritten as multiplied by the scaling factor. For example, the rewritten file and the original file may both be saved. Alternatively, the bit-depth of the audio file may be expanded during normalization. Unfortunately, many such algorithms have the disadvantage of taking up additional disk space, a problem that is exacerbated if a large portion of video data, for example, also needs to be copied along with the altered audio data. Expanding the bit-depth of an audio file may decrease playback performance, and may be overly complex or impossible to perform if the audio is encoded or contained in an audio/video multiplexed file.

It would therefore be desirable to improve the normalization process for media files.

### BRIEF SUMMARY

In one embodiment, a computer-implemented method for playing media files is described, the method comprising: receiving a request to normalize at least one media file; determining a peak amplitude associated with the at least one media file; determining a target maximum volume associated with playback of the at least one media file; playing the at least one media file; and applying a constant scaling factor to the at least one media file substantially concurrently with playback, the scaling factor calculated to cause the peak amplitude to play at the target maximum volume.

In yet another embodiment, an audio system for playing audio files comprises: a processor that executes instructions; and a computer-readable memory that stores instructions that cause the processor, upon receiving a request to normalize at least one audio file, to play the at least one audio file by: determining a peak amplitude associated with the at least one audio file; determining a target maximum volume associated with playback of the at least one audio file; playing the at least one audio file; and applying a constant scaling factor to the at least one audio file substantially concurrently with playback, the scaling factor calculated to cause the peak amplitude to play at the target maximum volume.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an audio system for playing audio files, according to one illustrated embodiment.

FIG. 2 is a flow diagram illustrating a method for playing media files, according to one illustrated embodiment.

### DETAILED DESCRIPTION OF EMBODIMENTS OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, etc. In other instances, well-known structures and methods associated with audio devices, digital audio workstations and computing devices have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Example Audio System

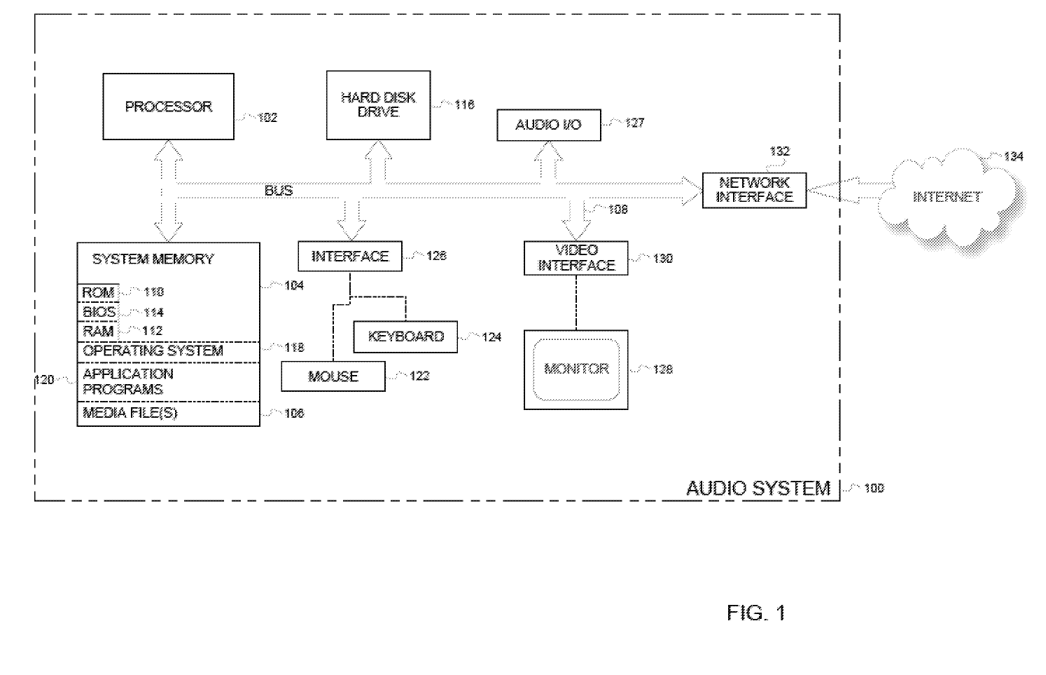

FIG. 1 and the following discussion provide a brief, general description of an audio system 100 configured for playing media files, such as audio files. While described in the context of an audio system 100, it may be understood that the same hardware described in detail herein may also be used to import and edit other types of media files, such as audio/video files. Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including digital audio and/or video editing hardware, handheld devices, multiprocessor systems, microprocessor-based or programmable consumer electronics, personal computers (“PCs”), network PCs, embedded systems, “set top boxes,” and the like. The embodiments can be practiced in distributed computing environments where tasks or modules are performed by remote processing devices, which are linked through a communications network. In a distributed computing environment, program modules may be located in both local and remote memory storage devices.

FIG. 1 shows an audio system 100, which comprises a computer. As illustrated, the audio system 100 may include a processor 102 that executes instructions, and a computer-readable system memory 104 that stores instructions that cause the processor 102, upon receiving a request to normalize at least one media file 106 (e.g., at least one audio file), to play the at least one media file 106 by: determining a peak amplitude associated with the at least one media file 106; determining a target maximum volume associated with playback of the at least one media file 106; playing the at least one media file 106; and applying a constant scaling factor to the at least one media file 106 substantially concurrently with playback, the scaling factor calculated to cause the peak amplitude to play at the target maximum volume. The audio system 100 and this method for playing at least one media file 106 will be described in greater detail below.

The audio system 100 may take the form of a conventional PC, which includes the processor 102, the system memory 104 and a system bus 108 that couples various system components including the system memory 104 to the processing unit 102. The audio system 100 will at times be referred to in the singular herein, but this is not intended to limit the embodiments to a single computing device, since in certain embodiments, there will be more than one networked computing device involved.

The processor 102 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 1 are of conventional design. As a result, such blocks need not be described in further detail herein, as they will be understood by those skilled in the relevant art.

The system bus 108 can employ any known bus structures or architectures, including a memory bus with memory controller, a peripheral bus, and a local bus. The system memory 104 includes read-only memory (“ROM”) 110 and random access memory (“RAM”) 112. A basic input/output system (“BIOS”) 114, which can form part of the ROM 110, contains basic routines that may help transfer information between elements within the audio system 100 (e.g., during start-up).

The audio system 100 also includes a hard disk drive 116 for reading from and writing to a hard disk. Though not shown, the audio system 100 may further or alternatively include other storage devices, such as an optical disk drive and/or a flash-based storage device. The hard disk drive 116 communicates with the processor 102 via the system bus 108. The hard disk drive 116 may include interfaces or controllers (not shown) coupled between the hard disk drive 116 and the system bus 108. The hard disk drive 116, and its associated computer-readable media may provide nonvolatile storage of computer-readable instructions, media files 106, program modules and other data for the audio system 100.

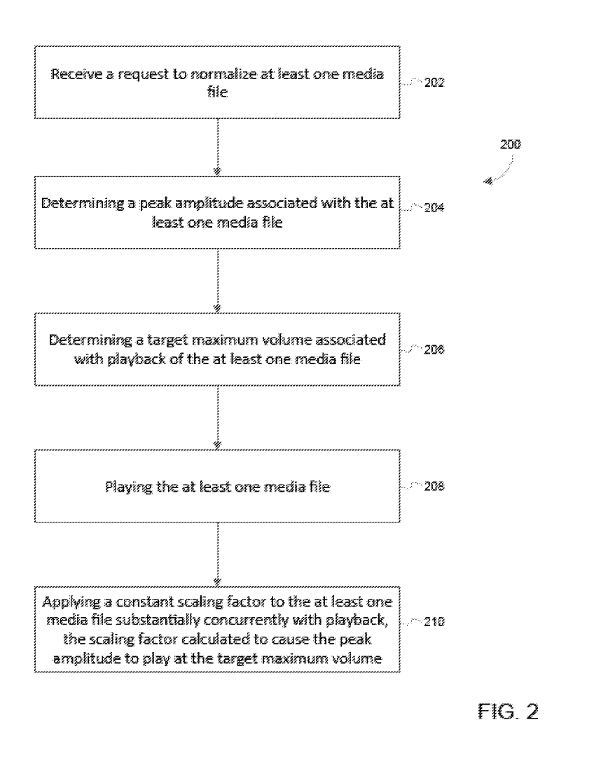

A variety of program modules can be stored in the system memory 104, including an operating system 118, one or more application programs 120, and at least one media file 106. In one embodiment, at least one of the application programs 120 may enable the normalization and playback of at least one media file 106. In such an embodiment, this application program 120 may provide much of the functionality described below with reference to FIG. 2. While shown in FIG. 1 as being stored in the system memory 104, the operating system 118, application programs 120, and at least one media file 106 can be stored in a nonvolatile storage device, such as the hard disk drive 116.

A user can enter commands and information into the audio system 100 using a mouse 122 and/or a keyboard 124. Other input devices can include a microphone, other musical instruments, scanner, etc. In one embodiment, one or more of these input devices may be used in order to interact with and edit the media files 106. These and other input devices are connected to the processor 102 through an interface 126 such as a universal serial bus (“USB”) interface that couples to the system bus 108, although other interfaces such as another serial port, a game port or a wireless interface may also be used. The audio system 100 may further include an audio I/O interface 127, such as a sound card. The audio I/O 127 may enable a user to import audio from an external source, and/or play audio on one or more speakers. A monitor 128 or other display device may be coupled to the system bus 108 via a video interface 130, such as a video adapter. Although not shown, the audio system 100 can include other output devices, such as printers.

In one embodiment, the audio system 100 operates in a networked environment using one or more logical connections to communicate with one or more remote computers or other computing devices. These logical connections may facilitate any known method of permitting computers to communicate, such as through one or more LANs and/or WANs, such as the Internet 134. In one embodiment, a network interface 132 (communicatively linked to the system bus 108) may be used for establishing communications over the logical connection to the Internet 134. In a networked environment, program modules, application programs, or media files, or portions thereof, can be stored outside of the audio system 100 (not shown). Those skilled in the relevant art will recognize that the network connections shown in FIG. 1 are only some examples of ways of establishing communications between computers, and other connections may be used.

### Discussion of a Method for Normalizing and Playing Media Files According to One Embodiment

FIG. 2 illustrates a flow diagram for a method 200 of playing media files, according to one embodiment. This method 200 will be discussed in the context of an application program executing on the audio system 100 illustrated in FIG. 1. However, it may be understood that the acts disclosed herein may also be executed in different software or hardware-based workstations used to work with a variety of media files in accordance with the described method.

The method begins at act 202, when a request is received to normalize at least one media file 106. The at least one media file 106 may comprise any of a variety of media files having an aural component, including audio files or audio/video files. The at least one media file 106 may also be stored in any of a variety of formats (e.g., Quicktime, MPEG, Sound Designer II, WAV, BWV or AIFF). The at least one media file 106 may be locally stored (as illustrated in FIG. 1) in a hard disk drive 116 or on another non-volatile or volatile storage device associated with the audio system 100. In another embodiment, the at least one media file 106 may be remotely stored and may be accessed via a network connection (e.g., via the Internet 134).

In one embodiment, the normalization request may correspond to a single media file 106. However, in other embodiments, a normalization request may correspond to a plurality of media files 106. For example, a user wishing to listen to a playlist filled with songs may request that the entire playlist be normalized during playback.

In one embodiment, the request to normalize the at least one media file 106 is received by an application program 120 executing on the audio system 100, such as media editing or media playback software. For example, a request to normalize an audio file may be received by digital audio editing software. The request to normalize the at least one media file 106 may be initiated by a user interacting with the audio system 100. The user may initiate the request by accessing menu commands in a user interface of an application program 120. In one embodiment, the user may view a plurality of media files 106 on the monitor 128 and may select the at least one media file 106 for normalization using a keyboard 124 or mouse 122. In another embodiment, the user may simply request playback of at least one media file 106, and an application program 120 may interpret such a request to further require normalization. In other embodiments, the request to normalize the at least one media file 106 may be automatically generated by a script or another program module, including the operating system.

At 204, a peak amplitude associated with the at least one media file 106 is determined. As described above, the peak amplitude refers to the “loudest part” of the at least one media file 106. Some media files may have such peak amplitude information stored as meta information (e.g., as metadata). As used herein, the term “meta information” refers to any information that characterizes the content of a media file. As a subset of meta information, the term “metadata” is used to refer to information stored with a media file that characterizes the content of the media file. Metadata may be stored with the at least one media file 106 as embedded information, or in a separate file associated with the at least one media file 106, or in a number of other ways, such as a separate fork of the same file or in a database provided by the operating system.

Thus, in one embodiment, the peak amplitude associated with the at least one media file 106 may be determined by reading information indicative of the peak amplitude stored as meta information associated with the at least one media file 106. In one embodiment, the meta information may be stored with the at least one media file 106 as metadata. However, in other embodiments, the meta information may be stored separately from the at least one media file 106 (e.g., within an application program 120).

In other embodiments, determining the peak amplitude may include scanning the at least one media file 106 to find the peak amplitude. The peak amplitude may represent the loudest part of a single media file 106 or of multiple media files 106. In some embodiments, after scanning the at least one media file 106 to find the peak amplitude, information indicative of the peak amplitude may then be stored as meta information associated with the at least one media file 106. This may facilitate future normalization processes.

At 206, a target maximum volume associated with playback of the at least one media file 106 is determined. In one embodiment, the user may interact with a user interface generated by an application program 120 executing on the audio system 100 in order to set the target maximum volume. For example, the user may interact with one or more menus or execute keyboard commands by manipulating the mouse 122 and/or keyboard 124 in order to set the target maximum volume. In other embodiments, the target maximum volume may be automatically set by a program executing on the audio system 100 (e.g., it may be preset to 0 dBFS). In one embodiment, an application program 120 may determine volume limitations associated with audio playback hardware or processing used and may automatically set the target maximum volume so as not to exceed those limitations.

Determining the target maximum volume may be performed at any point during the method 200, either by querying the user immediately after the request of act 202, or before the act 202, by having a preset (often 0 dBFS) value. In some embodiments, the target maximum value may be determined after determining the peak amplitude associated with the at least one media file in act 204. For example, multiple media files may be grouped for normalization, and playback of all of the files may be calibrated based on the loudest of the files.

At 208, the at least one media file 106 is played. In one embodiment, the at least one media file 106 is played via one or more audio output devices of the audio system 100. In one embodiment, the user may interact with a user interface generated by an application program 120 executing on the audio system 100 in order to cause the at least one media file 106 to play. In other embodiments, the at least one media file 106 may be automatically played by a program executing on the audio system 100.

At 210, a constant scaling factor is applied to the at least one media file 106 substantially concurrently with playback, the scaling factor calculated to cause the peak amplitude to play at the target maximum volume. In one embodiment, the scaling factor is simply applied as a multiplication factor in order to achieve the desired gain such that the peak amplitude plays at the target maximum volume. In one embodiment, the scaling factor may also be applied substantially concurrently with applying volume changes and other effects.

In one embodiment, by applying the constant scaling factor during playback rather than in advance of playback, the at least one media file 106 need not be written back to a disk in a normalized format. Thus, it may not be necessary to truncate or dither the results of the normalization. Generally, of course, the audio system 100 must truncate or dither the final output during playback or when it outputs its final product. However, this truncation/dither may need to be performed regardless, and a single truncation/dither may be superior to multiple truncation/dither steps.

In many embodiments, the performance impact of implementing the gain change during playback may be relatively minor, since it may simply comprise vector multiplication by a constant and may be well-suited to optimization by modern vector engines such as MMX. Moreover, many modern workstations already perform a multiplication operation when they convert the incoming data (frequently integer data) to floating point data to scale it to the standard range of ±1.0.

The normalization process for playback can be undone by simply playing the original at least one media file 106 without applying the scaling factor, and the scaling factor may be saved so that the user can apply it again. In one embodiment, the audio system 100 may also be configured to stop playback or warn the user if there is a significant change in gain, with or without the scaling factor, as this might surprise the user or damage audio equipment.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any processor-related system or method. In the context of this document, a memory is a computer readable medium that is an electronic, magnetic, optical, or other physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer readable medium” can be any means that can store, communicate, propagate, or transport the program associated with logic and/or information for use by or in connection with the instruction execution system, apparatus, and/or device. The computer readable medium can be, for example, but is not limited to, an electronic, magnetic, optical, electromagnetic, infrared, or semiconductor system, apparatus, device, or propagation medium. More specific examples (a nonexhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A computer-implemented method for playing media files, the method comprising:
receiving a request to normalize at least one media file;
determining a peak amplitude associated with the at least one media file;
determining a target maximum volume associated with playback of the at least one media file;
playing the at least one media file; and
applying a constant scaling factor to the at least one media file substantially concurrently with playback, the scaling factor calculated to cause the peak amplitude to play at the target maximum volume.

2. The method of claim 1, wherein the at least one media file is an audio file.

3. The method of claim 1, wherein the at least one media file is an audio/video file.

4. The method of claim 1, wherein determining the peak amplitude includes scanning the at least one media file to find the peak amplitude.

5. The method of claim 4, further comprising, after scanning the at least one media file to find the peak amplitude, storing information indicative of the peak amplitude as meta information associated with the at least one media file.

6. The method of claim 1, wherein determining the peak amplitude includes reading information indicative of the peak amplitude stored as meta information associated with the at least one media file.

7. The method of claim 1, wherein applying the constant scaling factor is performed substantially concurrently with applying volume changes or other effects.

8. An audio system for playing audio files, comprising:
a processor that executes instructions; and
a computer-readable memory that stores instructions that cause the processor, upon receiving a request to normalize at least one audio file, to play the at least one media file by:
determining a peak amplitude associated with the at least one audio file;
determining a target maximum volume associated with playback of the at least one audio file;
playing the at least one audio file; and
applying a constant scaling factor to the at least one audio file substantially concurrently with playback, the scaling factor calculated to cause the peak amplitude to play at the target maximum volume.

9. The audio system of claim 8, wherein determining the peak amplitude includes scanning the at least one audio file to find the peak amplitude.

10. The audio system of claim 9, wherein the computer-readable memory stores further instructions that cause the processor to, after scanning the at least one audio file to find the peak amplitude, store information indicative of the peak amplitude as meta information associated with the at least one audio file.

11. The audio system of claim 8, wherein determining the peak amplitude includes reading information indicative of the peak amplitude stored as meta information associated with the at least one audio file.

12. The audio system of claim 8, wherein applying the constant scaling factor is performed substantially concurrently with applying volume changes or other effects.

13. A computer-readable medium that stores instructions that cause a processor, upon receiving a request to normalize at least one media file, to play the at least one media file by:
determining a peak amplitude associated with the at least one media file;
determining a target maximum volume associated with playback of the at least one media file;
playing the at least one media file; and
applying a constant scaling factor to the at least one media file substantially concurrently with playback, the scaling factor calculated to cause the peak amplitude to play at the target maximum volume.

14. The computer-readable medium of claim 13, wherein the at least one media file is one of an audio file and an audio/video file.

15. The computer-readable medium of claim 13, wherein determining the peak amplitude includes scanning the at least one media file to find the peak amplitude.

16. The computer-readable medium of claim 15, wherein the computer-readable medium stores further instructions that cause the processor to, after scanning the at least one media file to find the peak amplitude, storing information indicative of the peak amplitude as meta information associated with the at least one media file.

17. The computer-readable medium of claim 13, wherein determining the peak amplitude includes reading information indicative of the peak amplitude stored as meta information associated with the at least one media file.

18. The computer-readable medium of claim 13, wherein applying the constant scaling factor is performed substantially concurrently with applying volume changes or other effects.
